(19) United States
(12) Patent Application Publication
(10) Pub. No.: US 2013/0219105 A1
(43) Pub. Date: Aug. 22, 2013

(54) METHOD, DEVICE AND SYSTEM FOR CACHING FOR NON-VOLATILE MEMORY DEVICE

(71) Applicant: Emanuele Confalonieri, Lesmo (Milano) (IT)

(72) Inventor: Emanuele Confalonieri, Lesmo (Milano) (IT)

(73) Assignee: Micron Technology, Inc., Boise, ID (US)

(21) Appl. No.: 13/398,609

(22) Filed: Feb. 16, 2012

(51) Int. Cl. G06F 12/08; G06F 12/02

(52) U.S. Cl. 711/103; 711/130; 711/E12.008; 711/E12.017

(57) ABSTRACT

Example embodiments described herein may relate to memory devices, and may relate more particularly to caching for non-volatile memory devices.

### BACKGROUND

Subject matter disclosed herein may relate to memory devices, and may relate, more particularly, to caching using non-volatile memory devices.

Non-volatile memory devices may be found in a wide range of electronic devices. For example, non-volatile memory devices may be used in computers, digital cameras, cellular telephones, personal digital assistants, etc. Non-volatile memory devices may also be incorporated into solid state storage drives for use with computer systems and/or other electronic devices, for example. As an additional example, non-volatile memory devices may also comprise memory cards compatible or compliant with Multi Media Card specification version 4.4, also known as JEDEC Embedded MMC (eMMC) Standard MMCA 4.4 (JESD84-A44) (March 2009; available from MMCA).

### BRIEF DESCRIPTION OF THE DRAWINGS

Claimed subject matter is particularly pointed out and/or distinctly claimed in the concluding portion of the specification. However, both as to organization and/or method of operation, together with objects, features, and/or advantages thereof, it may be better understood by reference to the following detailed description if read with the accompanying drawings in which:

FIG. 1 is a schematic block diagram illustrating an example embodiment of a computing platform.

FIG. 2 is a schematic block diagram depicting an example embodiment of a non-volatile memory device.

FIG. 3 is a block diagram depicting an example conceptual view of an example cache architecture for an example embodiment of a non-volatile memory device.

FIG. 4 is a block diagram depicting an example schematic view of an example cache architecture for another example embodiment of a non-volatile memory device.

FIG. 5 is block diagram depicting example cache control circuitry for an example embodiment of a non-volatile memory device.

FIG. 6 is a flow diagram illustrating an example embodiment of a process for reading one or more signals from an example embodiment of a non-volatile memory device comprising an example cache.

FIG. 7 is a flow diagram depicting an example embodiment of a process for writing one or more signals to an example embodiment of a non-volatile memory device comprising an example cache.

FIG. 8 is a block diagram depicting an example conceptual view of an example memory partitioning scheme of an example non-volatile memory device.

FIG. 9 is a schematic block diagram illustrating an example embodiment of a computing platform.

Reference is made in the following detailed description to the accompanying drawings, which form a part hereof, wherein like numerals may designate like parts throughout to indicate corresponding and/or analogous components. It will be appreciated that for simplicity and/or clarity of illustration, components illustrated in the figures have not necessarily been drawn to scale. For example, the dimensions of some may be exaggerated relative to others. Further, it is to be understood that other embodiments may be utilized. Furthermore, structural and/or logical changes may be made without departing from the scope of claimed subject matter. It should also be noted that directions, references and/or other position indications, for example, such as, up, down, top, bottom, and so on, may be used to facilitate discussion of the drawings and are not intended to restrict the application of claimed subject matter. Therefore, the following detailed description is not to be taken to limit the scope of claimed subject matter and/or its equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses and/or systems that would be known by one of ordinary skill have not been described in detail so as not to obscure claimed subject matter.

As mentioned above, non-volatile memory devices may be found in a wide range of electronic devices. For example, non-volatile memory devices may be used in computers, digital cameras, cellular telephones, personal digital assistants, etc. Non-volatile memory devices may also be incorporated into solid state storage drives for use with computer systems and/or other electronic devices, for example. Some embodiments of non-volatile memory devices may comprise memory cards, for example, although the scope of claimed subject matter is not limited in this respect. For example, in an embodiment, a memory device may comprise a memory card compatible and/or compliant with MultiMediaCard specification version 4.4, previously referenced.

Non-volatile memory devices may comprise a controller to manage memory operations for one or more arrays of non-volatile memory cells, such as reading from and/or writing to memory cells, for example. In at least some circumstances, two or more arrays of non-volatile memory cells may be implemented using two or more different memory technologies. In this context, the term different memory technologies is intended to refer to memory technology in which techniques to read and/or write to a memory cell of an array employ different physical processes. As a simple example, NAND flash memory (referred to as NAND) technology is considered in this context to be a different memory technology than Phase Change Memory (referred to as PCM) technology. Likewise, the term hybrid in this context refers to a situation in which different memory technologies are employed together in a particular system, device, component, product, etc. Two or more arrays of non-volatile memory cells implemented using two or more different memory technologies may be implemented on two or more integrated circuit die in some circumstances, for example, although claimed subject matter is not limited in this respect.

Example hybrid memory architectures incorporating two or more memory cell technologies, perhaps implemented on two or more respective integrated circuit die, may allow enhancement of system performance for at least a portion of a logical address space, sometimes also referred to as a virtual address space. In this context, the term logical address space refers to consecutive memory address locations for memory cells that do not necessarily correspond to consecutive physical memory cell locations. To enhance system performance for an address space, a caching mechanism may be utilized, in an example embodiment. Caching refers to memory storage intended to be short term with relatively faster access time than memory storage intended to be long term. Therefore, for example, state information intended to be accessed repeatedly may be made available on a temporary basis using memory that may be relatively faster to access to enhance overall system performance. Typically, relatively faster memory may be more expensive and so there may be less storage available. As a result, much state information may be stored in longer term memory and moved to shorter term memory on a “real-time” basis, for example. Cached state information may therefore comprise a subset of state information stored in one or more other arrays of non-volatile memory cells, in an embodiment.

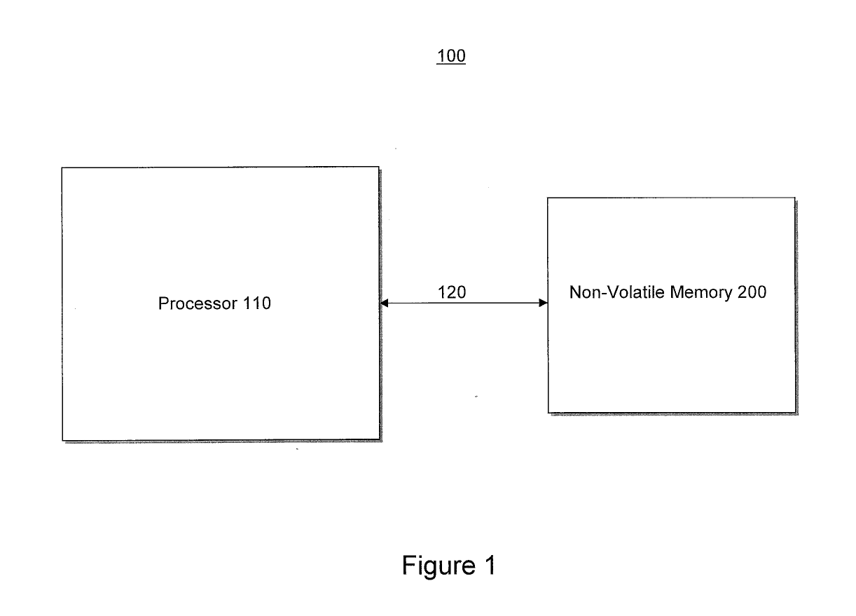

FIG. 1 is a block diagram of an example embodiment 100 of a computing platform, comprising processor 110 and non-volatile memory 200. For an example embodiment, non-volatile memory device 200 may comprise phase-change memory (PCM) and NAND memory technologies, although claimed subject matter is not limited in scope in this respect. In an embodiment, memory 200 may comprise any memory technologies currently existing or yet to be developed.

In this context, PCM technology comprises memory technology in which a physical state of a cell may be changed by application of a sufficient amount of heat. Memory 200, for an example embodiment, may be coupled to processor 110 by way of interconnect, such as bus 120. In an example embodiment, bus 120 may comprise a parallel bus, although claimed subject matter is not limited in scope in this respect. Also for an embodiment, processor 110 may fetch states and/or signals comprising executable instructions stored in memory 200, and processor 110 may execute states and/or signals comprising fetched instructions. Signals and/or states representing executable instructions, for example, may also be written to and/or read from memory 200 by processor 110. A controller within non-volatile memory 200 executing states and/or signals representing firmware instructions stored within non-volatile memory 200 may be utilized to implement read and/or write accesses, in accordance with signals and/or states representing one or more command codes received from processor 110, for example. For an example embodiment, a configuration of computing platform 100 may comprise an execute-in-place (XiP) implementation, wherein processor 110 may fetch signals and/or states representing instructions to be executed from long-term memory, comprising non-volatile memory device 200 for this example. An example of a non-XiP implementation may comprise a processor fetching signals and/or states representing stored instructions from a volatile memory device, such as a dynamic random access memory (DRAM), for example.

As used herein, “computing platform” refers to a system and/or a device that includes an ability to store and process electrical signals. Typically, a computing system may include a processor, a memory and a bus coupling the processor and memory. For example, signals to be processed may be stored in memory as states ahead of processing. Likewise, results of processing may be stored in memory as states after processing. A computing platform, in this context, may comprise hardware, software, firmware or any combination thereof (excluding software per se).

Computing platform 100, as depicted in FIG. 1, is merely an example, and claimed subject matter is not limited in scope to this example. For one or more embodiments, for example, a computing platform may comprise any of a wide range of digital electronic devices, including, but not limited to, personal desktop and/or notebook computers, high-definition televisions, digital versatile disc (DVD) players and/or recorders, game consoles, satellite television receivers, cellular telephones, personal digital assistants, mobile audio and/or video playback and/or recording devices, etc., including any combinations thereof. Further, unless specifically stated otherwise, a process as described herein, with reference to flow diagrams and/or otherwise, may also be executed and/or controlled, in whole or in part, by a computing platform. For example embodiments described herein, computing platform 100 may comprise a cellular telephone, although, again, the scope of claimed subject matter is not so limited.

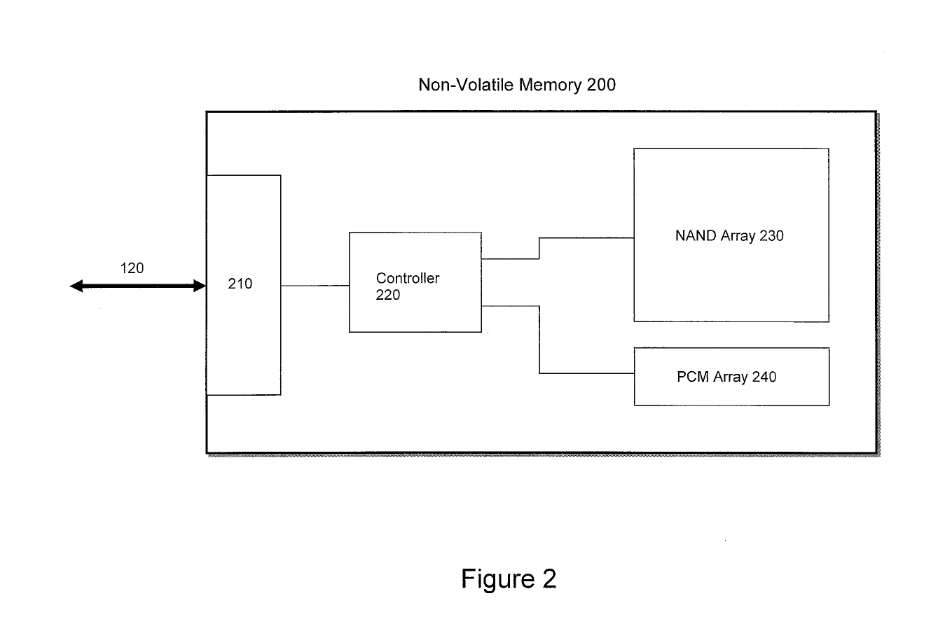

FIG. 2 is a schematic block diagram depicting an example embodiment of non-volatile memory device 200 including interconnect interface 210, for an example. In an embodiment, signals and/or states indicative of executable instructions, commands or other stored information may be transmitted by processor 110 to memory device 200 via interconnect interface 210 and interconnect 120. Likewise, signals and/or states indicative of executable instructions, commands or other stored information may also be retrieved by processor 110 from memory device 200 via interconnect interface 210 and interconnection 120, in an embodiment. Memory device 200 may also transmit and/or receive signals and/or state representative of stored memory address or stored content information via interconnect interface 210. For one or more embodiments, a controller 220 may receive one or more signals and/or states indicative of commands and/or other stored information from processor 110 via interconnect 120 and interface 210, and may generate one or more internal control signals to perform any of a number of operations, including read and/or write operations, by which processor 110 may access a PCM array 240 and/or a NAND array 230, for example.

An example type of non-volatile memory device may comprise a phase change memory (PCM) device, for an example embodiment. Phase change memory devices may be characterized at least in part in accordance with a manner in which state information may be stored in individual memory cells. Stored contents of a particular memory cell may depend at least in part on a physical state of memory cell material for the particular memory cell, such as more crystalline or more amorphous. Typically, a more amorphous cell is more resistive whereas a more crystalline cell is more conductive.

As used herein, “controller” refers to any circuitry, including hardware and/or firmware logic, involved in management and/or execution of signals and/or state representing command sequences as they relate memory operations of non-volatile memory devices. “Controller” further refers to an ability to execute hardware and/or firmware instructions as part of management and/or execution of command sequences, in an embodiment. Similarly, “control circuitry” refers to any circuitry, including hardware and/or firmware logic, involved in management and/or execution of signals and/or states representing command sequences as they relate to memory operations of non-volatile memory devices. In an embodiment, “controller” and/or “control circuitry” may comprise circuitry, including hardware and/or firmware logic, involved in cache operations, examples of which are described below. Also in one or more embodiments, “control circuitry” may refer to an ability to execute firmware and/or hardware instructions as part of management and/or execution of cache operations, in an embodiment.

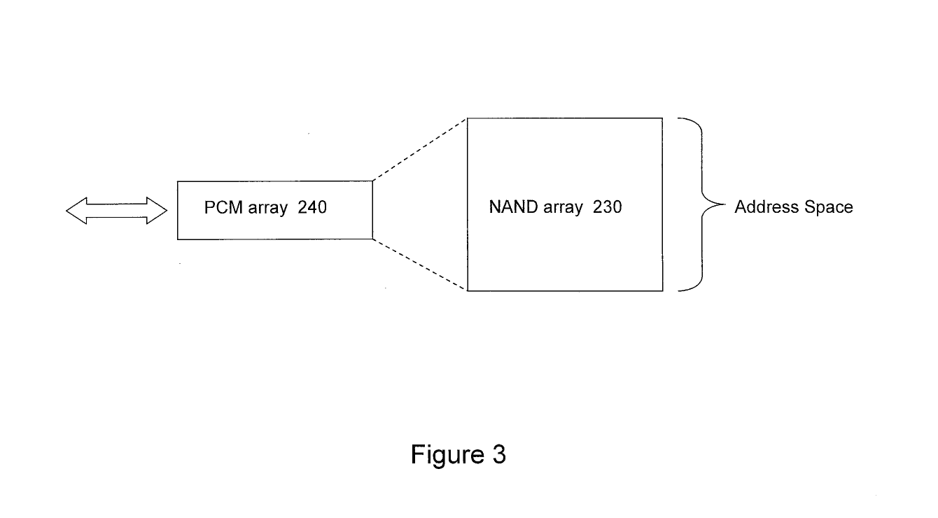

FIG. 3 is a block diagram depicting an example conceptual view of an example cache architecture for an example embodiment of non-volatile memory device 200. In an embodiment, cache operations may be based at least in part on logical memory addresses rather than physical memory addresses. Use of logical addresses in a PCM cell array cache, rather than physical addresses, may provide performance and/or other implementation related benefits.

In an embodiment, one or more signals and/or state received at memory device 200 representing blocks of information in the form of values of signals and/or states may be cached in PCM array 240. Cached states may comprise at least a subset of states stored in NAND array 230, in an embodiment. Although PCM and NAND memory technologies are described herein, embodiments of claimed subject matter are, of course, not limited in scope to PCM memory technology and/or NAND memory technology. Rather, these memory technologies are meant to be illustrative. Nonetheless, in an embodiment, a PCM cell array may be selected to be used as a cache due at least in part to one or more implementation and/or performance benefits as compared with flash memory technology, for example. In an embodiment, a contiguous address space of a memory device, as depicted schematically in FIG. 3, may realize or one or more implementation and/or performance benefits, for example.

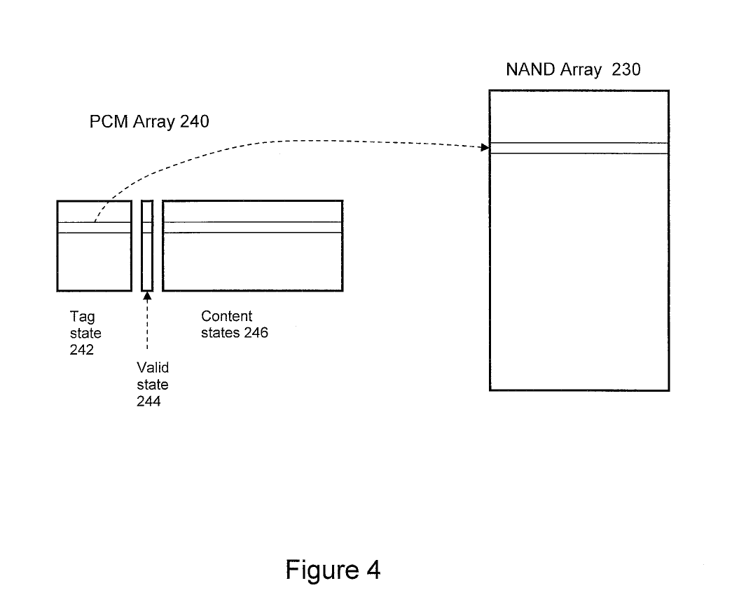

FIG. 4 is a block diagram depicting a schematic view of an example cache architecture for an embodiment. In an embodiment, for example, PCM array 240 may be partitioned into a plurality of state entries. Individual entries may comprise a tag state 242 and a cache coherency information state 244. State 244 may also be referred to as a valid state since it may comprise a state representing a “valid” binary digital signal (also referred to as a bit) or a “dirty” binary digital signal (also referred to as a bit).

In an embodiment, individual state entries of PCM array 240 may also comprise content 246. Content 246 may store states indicative of executable instructions or other stored information. Individual entries of PCM array 240 may be associated via state values stored as tag 242 with one or more storage blocks within NAND array 230. Conversely, in an example embodiment, individual storage blocks within NAND array 230 may be associated with a single entry in PCM array 240. In an embodiment, storage locations within NAND array 230 may store one or more pages of state information, although claimed subject matter is not limited to any particular organization of NAND array 230. Of course, cache and/or memory organizations described herein and as depicted in figures are merely examples, and claimed subject matter is not limited in scope in these respects.

In an example embodiment, a cache implemented as a PCM cell array may comprise a direct-mapped architecture, although claimed subject matter is not limited in scope in this respect. In an embodiment, a direct-mapped cache may provide relatively fast performance and relatively low power consumption in comparison with alternative approaches, such as a fully associative or set associative architecture, for example. Nonetheless, claimed subject matter is not limited in scope to a particular architecture. Continuing with this example, however, individual PCM cell array cache entries may comprise 512 bytes of stored state information and individual blocks of a NAND cell array may comprise 4 kBytes of stored state information storage, although again, claimed subject matter is not limited in scope in these respects.

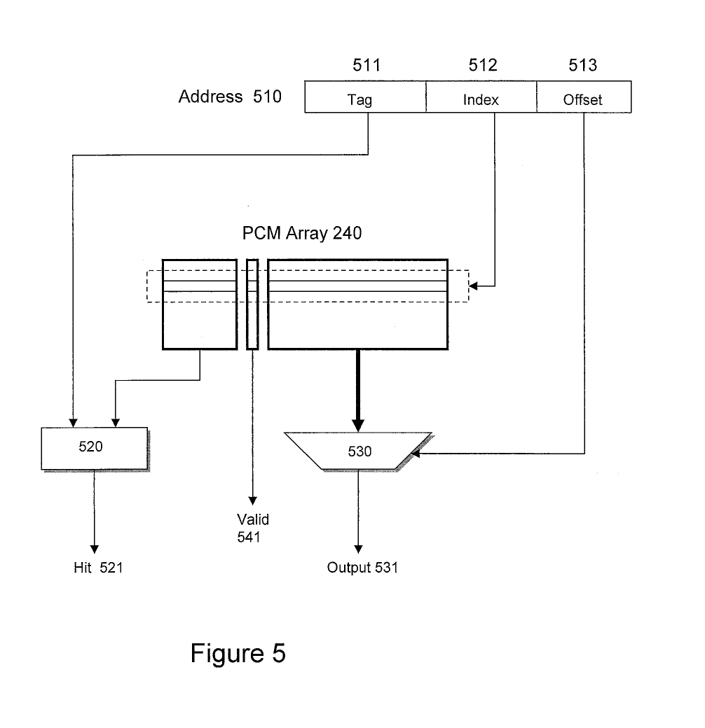

FIG. 5 is block diagram depicting example cache control circuitry for an example embodiment. Example control circuitry may comprise, at least in part, tag compare circuitry 520 and multiplexer 530. A memory address location 510 for the example depicted in FIG. 5 may represent address signal information gleaned from a memory access command received from processor 110. In an embodiment, memory address location 510 may comprise a tag signal portion 511, an index signal portion 512, and an offset signal portion 513. Tag portion 511 in an embodiment may represent an identifier of a plurality of identifiers, wherein the plurality of identifiers may be individually associated with a storage location within NAND array 230. In an embodiment, PCM array 240 may store at least a subset of states stored with NAND array 230. To determine whether PCM array 240 has cached therein a copy of contents of a particular storage location located within NAND array 230, tag portion 511 of address 510 may be compared with tag 242 from a state entry within PCM array 240 identified by index 512. If a tag match is determined between tag 511 and tag 242, a hit signal 521 may be asserted to indicate a “cache hit.” If no match is found, hit signal 521 may not be asserted, thereby indicating a “cache miss.” Also in an embodiment, offset state value 513 may select a subset of a block of cached signals to be provided as output signal 531 by way of multiplexer 530.

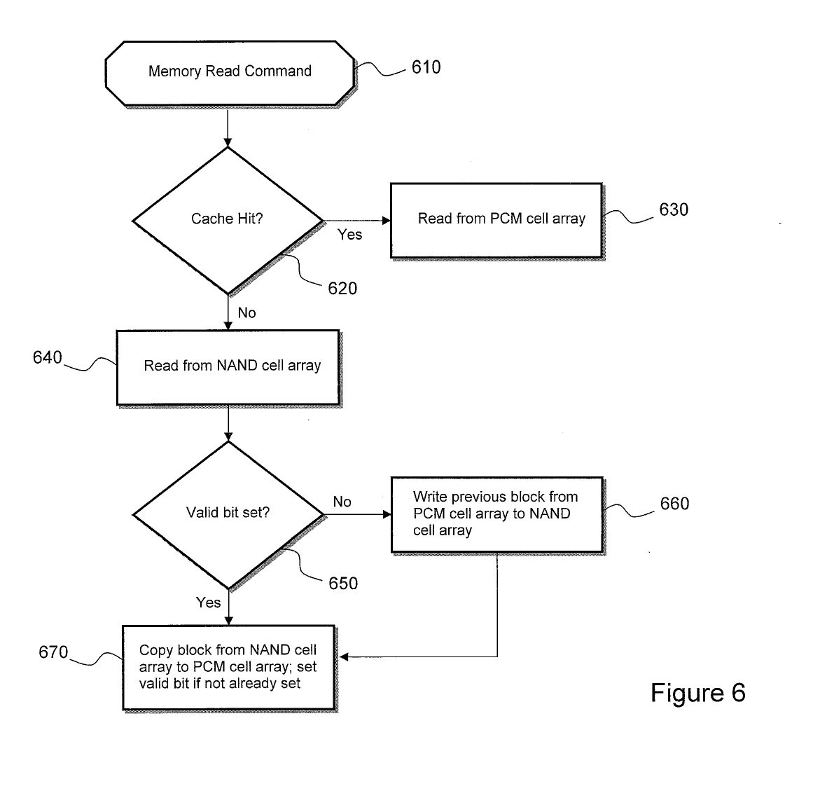

FIG. 6 is a flow diagram illustrating an example embodiment of a process for reading a non-volatile memory device comprising an example cache. Example processes may be utilized in connection with example embodiments of PCM and NAND cell arrays, such as those discussed above and as depicted in the figures, although claimed subject matter is not limited in scope in these respects.

At block 610, one or more signals indicative of a memory read command may be received at a non-volatile memory device comprising a first array of non-volatile memory cells and a second array of non-volatile memory cells, wherein the read command may include a related memory address location. In an example embodiment, the first array of non-volatile memory cells may comprise a PCM cell array and the second array of non-volatile memory cells may comprise a NAND cell array. Further, in an example embodiment, a determination may be made as to whether a tag portion of the related memory address location matches a tag state value stored in an entry of the PCM cell array. The entry of the PCM cell array may be indicated by an index portion of the related memory address location, in an embodiment. As indicated at block 620, if a cache hit is determined by a match of a tag portion with a stored tag state value, stored state information may be read from the PCM cell array. That is, as indicated at block 630, stored state information may be read from an information storage location of the first array of non-volatile memory cells at least in part in response to a determination that a tag portion of the related memory address location matches a stored tag state value of an entry of the PCM cell array indicated by the index portion of the memory address location. In an embodiment, an entry of a PCM cell array indicated by an index portion of the memory address location, for example, may also have stored state information for the entry.

Further, in an embodiment, at least in part in response to a cache miss, as indicated at block 640, state information stored in a NAND cell array may be read and provided in response to the read command. The particular location of the NAND cell array may be based at least in part on the memory address location related to the read command. In an embodiment, state information read from the NAND cell array may be transmitted to a processor in response to a cache miss.

However, in an embodiment, at least in part in response to a cache miss, a determination may be made as to whether a valid bit is set for the entry of the PCM cell array identified by the index portion of the memory address location related to the read command. A “set” condition of a valid bit may indicate that the state information stored by the NAND cell array identified by the PCM cell entry matches the state information stored at the PCM cell array entry. In other words, a set value of a valid bit may indicate that copies of state information stored in the entry of the PCM cell array and the memory location of the NAND cell array indicated by the entry are identical, in an embodiment. However, a cleared valid bit may indicate that state information stored in the PCM cell array entry does not match state information stored at a memory location of the NAND cell array indicated by the entry.

As indicated at block 660, at least in part in response to a determination that a valid bit is not set, state information stored in the PCM cell array at an entry identified by an index portion of the memory address location may be written from the PCM cell array entry to the NAND cell array indicated by the entry for consistency between state information of the PCM cell array and NAND cell array. Further, as indicated at block 670, at least in part in response to reading state information from the NAND cell array, state information stored in the NAND cell array read in response to the read command that generated a cache miss may be copied to an entry of the PCM cell array. In this manner, state information recently read by a processor, for example, may be stored in the PCM cell array to improve overall system performance by attempting to maintain frequently used state information in a relatively higher performance array of memory cells. Embodiments in accordance with claimed subject matter may, of course, include all of, less than, or more than these blocks and this particular order of blocks is provided merely as an example.

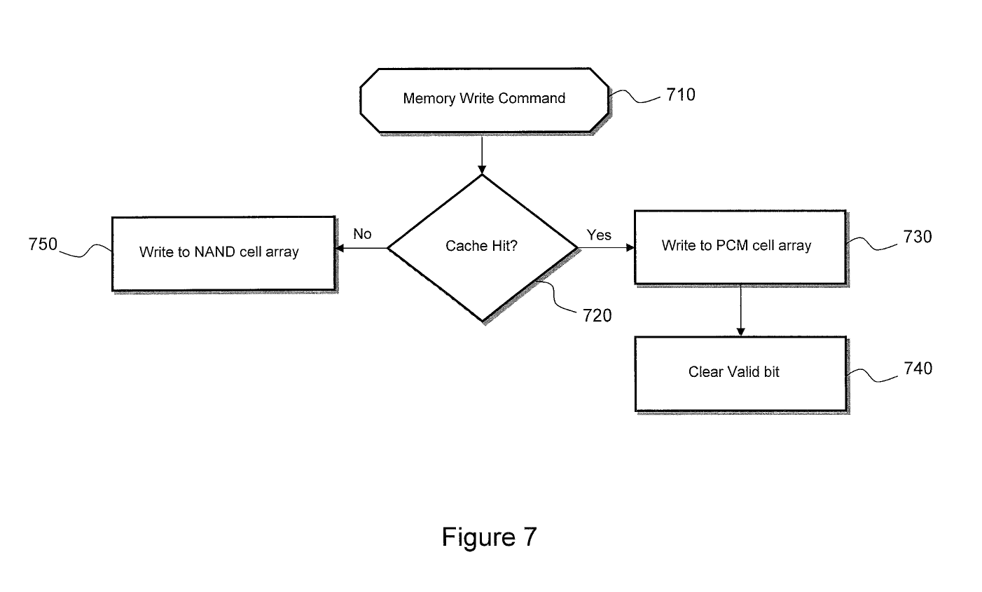

FIG. 7 is a flow diagram depicting an example embodiment of a process for writing to a non-volatile memory device comprising an example cache. In an embodiment, a cache may comprise a PCM cell array, although claimed subject matter is not limited in scope in this respect. In an embodiment, a non-volatile memory device may receive one or more signals indicative of a write command from a processor, for example, as indicated at block 710. In an embodiment, the write command may include a related memory address location. Also in an embodiment, a determination may be made as to whether a tag portion of the memory address location matches a stored tag state value for an entry in the PCM cell array identified by an index portion of the memory address location, as depicted at block 720 of FIG. 7.

At least in part in response to a determination at block 720 of a tag match indicating a cache hit, state information stored at the entry of the PCM cell array identified by the index portion of the memory address location related to memory write command may be updated, as indicated at block 730. Additionally, in an embodiment, a valid bit associated with the updated entry of the PCM cell array may be cleared at block 740 to indicate that state information stored in the NAND cell corresponding to the entry of the PCM array may be stale.

Additionally, at least in part in response to a determination at block 720 of no tag match indicating a cache miss, as indicated at block 750, information stored in the NAND cell array at the memory address location related to the memory write command may be updated. Embodiments in accordance with claimed subject matter may, of course, include all of, less than, or more than these blocks and this particular order of blocks is provided merely as an example.

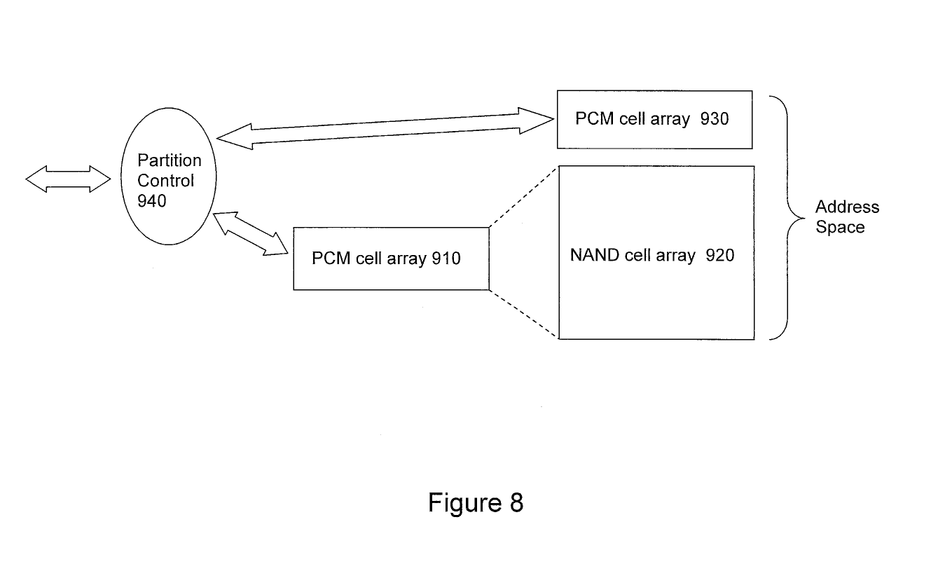

FIG. 8 is a block diagram depicting a conceptual view of a memory partitioning scheme of an example non-volatile memory device. In an embodiment, a memory device may comprise a logical address space comprising PCM cell array 930 and NAND cell array 920. A PCM cell array 910 may serve as a cache for NAND device 920. By utilizing PCM cell array 910 as a cache for NAND cell array 920, at least some of the potential benefits of PCM and/or NAND memory technologies may be realized. Greater bit density may be realized by utilizing NAND cell array 920, while improved access times may be realized by utilizing PCM cell array 910 as a cache, for example. In an embodiment, PCM cell array 910 may provide a cache for a subset of an address space for an example embodiment. A partition control unit 940 may explicitly manage access to a first partition of an address space, wherein the first partition comprises a PCM cell array 930. A second partition may comprise PCM cell array 910 and NAND cell array 920. Also in an embodiment, caching operations involving PCM cell array 910 and NAND cell array 920 may be implicitly managed utilizing, at least in part, control circuitry such as that depicted in FIG. 5, for an example.

Also, in an embodiment, additional numbers of partitions may be implemented for a non-volatile memory device. Individual partitions may have independent logical addresses. Likewise, embodiments of PCM cell array caches may employ logical addressing. Therefore, a single partition may be cached at any particular point in time, in an embodiment. At least in part in response to a partition switch command being issued to a memory device, a write back from a PCM cell array cache to a NAND cell array may be performed for state information consistency.

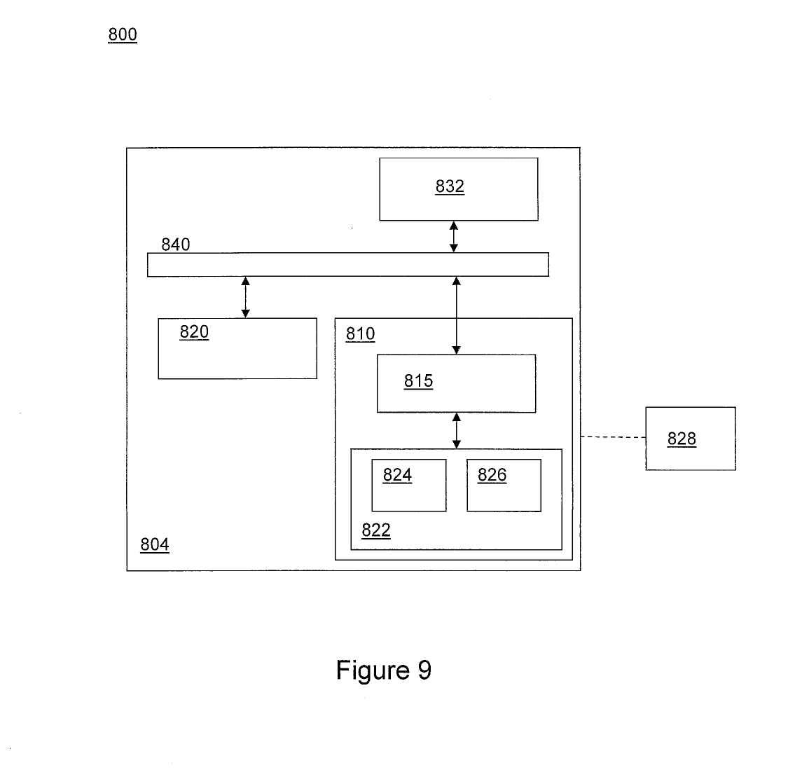

FIG. 9 is a schematic block diagram illustrating an example embodiment of a computing platform 800 including a memory device 810. Such a computing device may comprise one or more processors, for example, to execute an application and/or other code. For example, memory device 810 may comprise a non-volatile memory device, such as that depicted in FIG. 1. A computing device 804 may be representative of any device, appliance, or machine that may have a configuration to manage memory device 810. Memory device 810 may include a memory controller 815 and a memory 822. By way of example, but not limitation, computing device 804 may include: one or more computing devices and/or platforms, such as, e.g., a desktop computer, a laptop computer, a workstation, a server device, and/or the like; one or more personal computing, communication devices, and/or appliances, such as, e.g., a personal digital assistant, mobile communication device, and/or the like; a computing system and/or associated service provider capability, such as, e.g., a database and/or data storage service provider/system; and/or any combination thereof.

It is recognized that all or part of the various devices shown in system 800, and the processes and methods as further described herein, may be implemented using and/or otherwise including hardware, firmware, software, and/or any combination thereof (other than software per se). Thus, by way of example but not limitation, computing device 804 may include at least one processing unit 820 operatively coupled to memory 822 through a bus 840 and a host or memory controller 815. Processing unit 820 is representative of one or more circuits having a configuration to perform at least a portion of a computing procedure or process. By way of example but not limitation, processing unit 820 may include one or more processors, controllers, microprocessors, microcontrollers, application specific integrated circuits, digital signal processors, programmable logic devices, field programmable gate arrays, the like, and/or any combination thereof. Processing unit 820 may include an operating system having a configuration to communicate with memory controller 815. Such an operating system may, for example, generate commands to be sent to memory controller 815 via bus 840. In one implementation, memory controller 815 may comprise an internal memory controller and/or an internal write state machine, wherein an external memory controller (not shown) may be external to memory device 810 and may act as an interface between the system processor and the memory itself, for example. Memory 822 is representative of any storage mechanism. Memory 822 may include, for example, a primary memory 824 and/or a secondary memory 826. Memory 822 may comprise a non-volatile memory array, for example. While illustrated in this example as being separate from processing unit 820, it should be understood that all or part of primary memory 824 may be provided within and/or otherwise co-located/coupled with processing unit 820.

Memory device 810 may include, for example, functional units similar to those described above in connection with memory device 200, wherein functional units are provided to perform logical-to-physical address mapping operations related to one or more types of non-volatile memory technologies in one or more arrays of non-volatile memory cells. For example, in an embodiment, a PCM cell array may serve as an SLC array and a NAND array may comprise an MLC array. However, claimed subject matter is not limited in scope in these respects. In an embodiment, memory device 810 may comprise a single integrated circuit die, although in other embodiments memory device 810 may comprise two or more separate integrated circuit die, for example.

Secondary memory 826 may include, for example, the same or similar type of memory as primary memory and/or one or more storage devices and/or systems, such as, for example, a disk drive, an optical disc drive, a tape drive, a solid state memory drive, etc. In certain implementations, secondary memory 826 may be operatively receptive of, and/or otherwise have a configuration to couple to, a computer-readable medium 828. Computer-readable medium 828 may include, for example, any medium that can carry and/or make accessible memory states, such as code and/or instructions for one or more of the devices in system 800. Computing device 804 may or may not include a system memory, in an embodiment. For example, computing device 804 may comprise a dynamic random access memory for code execution, in an embodiment.

Computing device 804 may include, for example, an input/output 832. Input/output 832 is representative of one or more devices and/or features that may have a configuration to accept and/or otherwise introduce human and/or machine inputs, and/or one or more devices and/or features that may have a configuration to deliver and/or otherwise provide for human and/or machine outputs. By way of example, but not limitation, input/output device 832 may include an operative configuration of a display, speaker, keyboard, mouse, trackball, touch screen, data port, etc.

Reference throughout this specification to “one embodiment” and/or “an embodiment” may mean that a particular feature, structure, and/or characteristic described in connection with a particular embodiment may be included in at least one embodiment of claimed subject matter. Thus, appearances of the phrase “in one embodiment” and/or “an embodiment” in various places throughout this specification are not necessarily intended to refer to the same embodiment or to any one particular embodiment described. Furthermore, it is to be understood that particular features, structures, and/or characteristics described may be combined in various ways in one or more embodiments. In general, of course, these and other issues may vary with the particular context of usage. Therefore, the particular context of the description and/or the usage of these terms may provide helpful guidance regarding inferences to be drawn for that context.

Likewise, the terms, “and/or”, “and,” and “or” as used herein may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, and/or characteristic in the singular and/or may be used to describe some combination of features, structures and/or characteristics. Though, it should be noted that this is merely an illustrative example and claimed subject matter is not limited to this example.

Some portions of the detailed description included herein are presented in terms of algorithms and/or symbolic representations of operations on binary digital signals stored within a memory of a specific apparatus, computing device and/or platform. In the context of this particular specification, the term specific apparatus and/or the like includes a general purpose computing device once it is programmed to perform particular operations pursuant to instructions from program software. Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, quantities may take the form of electrical and/or magnetic signals and/or states capable of being stored, transferred, combined, compared and/or otherwise manipulated. It has proven convenient at times, principally for reasons of common usage, to refer to such signals and/or states as bits, data, values, elements, symbols, characters, terms, numbers, numerals, and/or the like. It should be understood, however, that all of these and/or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” and/or the like refer to actions and/or processes of a specific apparatus, such as a special purpose computer and/or computing device. In the context of this specification, therefore, a special purpose computer and/or computing device is capable of manipulating and/or transforming signals, typically represented as physical electronic and/or magnetic quantities within memories, registers, and/or other information storage devices, transmission devices, and/or display devices of the special purpose computer and/or computing device.

In some circumstances, operation of a memory device, such as a change in state from a binary one to a binary zero and/or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge and/or a release of stored charge. Likewise, in other memory devices, a change of state may comprise a physical change, such as transformation in magnetic orientation and/or transformation in molecular structure, such as from crystalline to amorphous or vice-versa. The foregoing is not intended to be an exhaustive list of all examples in which a change in state for a binary one to a binary zero and/or vice-versa in a memory device may comprise a transformation, such as a physical transformation. Rather, the foregoing is intended as illustrative examples.

A storage medium typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

In the preceding description, various aspects of claimed subject matter have been described. For purposes of explanation, systems and/or configurations were set forth to provide an understanding of claimed subject matter. However, claimed subject matter may be practiced without those specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A non-volatile memory device, comprising:
a first array of non-volatile memory cells to cache one or more blocks of state information; and
a second array of non-volatile memory cells to store a plurality of blocks of state information, wherein the one or more blocks of state information to be cached in the first array of memory cells comprises at least a subset of the plurality of blocks of state information to be stored in the second array of non-volatile memory cells;
wherein the first and second arrays of non-volatile memory cells employ different memory technology.

2. The non-volatile memory device of claim 1, wherein the non-volatile memory technology of the first array of non-volatile memory cells comprises a phase-change memory technology, and wherein the non-volatile memory technology of the second array of non-volatile memory cells comprises NAND memory technology.

3. The non-volatile memory device of claim 1, further comprising control circuitry to: determine whether a tag portion of a memory address location of a read command matches a stored tag state value in an entry of the first array of non-volatile memory cells indicated at least in part by an index portion of the memory address location.

4. The non-volatile memory device of claim 3, the control circuitry in response to the read command to further read state information from the entry indicated at least in part by the index portion of the memory address location if the tags match.

5. The non-volatile memory device of claim 3, the control circuitry in response to the read command to further read state information from a memory cell of the second array based at least in part on the memory address location if the tags to not match.

6. The non-volatile memory device of claim 5, the control circuitry to further write state information from the entry of the first array to a memory cell of the second array indicated by the entry of the first array if the tags do not match.

7. The non-volatile memory device of claim 6, the control circuitry to further write state information from a memory cell of the second array based at least in part on the memory address location to the entry of the first array if the tags do not match.

8. The non-volatile memory device of claim 1, further comprising control circuitry to determine whether a tag portion of a memory address location of a write command matches a stored tag state value in an entry of the first array of non-volatile memory cells indicated at least in part by an index portion of the memory address location.

9. The non-volatile memory device of claim 8, the control circuit in response to the write command to further update state information stored at the entry of the first array if the tags match.

10. The non-volatile memory device of claim 8, the control circuit in response to the write command to further update state information stored at a memory cell location of the second array indicated at least in part by the memory address location if the tags match.

11. A method, comprising:
caching one or more blocks of state information in a first array of non-volatile memory cells, the cached one or more blocks of state information comprising at least a subset of a plurality of blocks of state information stored in a second array of non-volatile memory cells; wherein the first array of non-volatile memory cells comprises a non-volatile memory technology type that differs from a non-volatile memory technology type of the second array of non-volatile memory cells.

12. The method of claim 11, wherein the non-volatile memory technology of the first array of non-volatile memory cells comprises a phase-change memory technology, and wherein the non-volatile memory technology of the second array of non-volatile memory cells comprises NAND memory technology.

13. The method of claim 11, further comprising:
receiving one or more signals indicative of a read command, the read command comprising an address;
determining whether a tag portion of the address matches a tag entry stored in the first array of non-volatile memory cells indicated by an index portion of the address; and
reading information from an information storage location in the first array of non-volatile memory cells at least in part in response to a determination that the tag portion of the address matches a tag entry indicated by the index portion of the address, the information storage location in the first array of non-volatile memory cells being associated with the tag entry indicated by the index portion of the address.

14. The method of claim 13, wherein the caching further comprises reading state information stored at an information storage location in the second array of non-volatile memory cells identified by the address of the read command at least in part in response to a determination that the tag portion of the address does not match the tag entry of the first array of non-volatile memory cells indicated by the index portion of the address.

15. The method of claim 14, further comprising:
determining whether a cache coherence field associated with the tag entry is set;
writing state information from the information storage location in the first array of non-volatile memory cells associated with the tag entry indicated by the index portion of the address to a storage location of the second array of non-volatile cells identified by an address stored in the first array of non-volatile memory cells at an entry indicated by the index portion of the address of the read command at least in part in response to a determination that the cache coherence field is set; and
copying state information stored at the information storage location in the second array of non-volatile memory cells identified by the address of the read command to an entry of the first array of non-volatile memory cells indicated by an index portion of the address of the read command.

16. The method of claim 11, wherein the caching comprises:
receiving one or more signals indicative of a write command, the write command comprising an address and state information to be written;
determining whether a tag portion of the address matches a tag entry stored in the first array of non-volatile memory cells, the tag entry indicated by an index portion of the address;
writing state information to an information storage location in the second array of non-volatile memory cells indicated by the address at least in part in response to a determination that the tag portion of the address does not match the tag entry.

17. The method of claim 16, wherein the caching further comprises:
writing state information to an information storage location of the first array of non-volatile memory cells at least in part in response to a determination that the tag portion of the address matches the tag entry, the information storage location of the first array of non-volatile memory cells being associated with the tag entry
clearing a cache coherence field associated with the tag entry at least in part in response to the writing state information to the information storage location of the first array of memory cells.

18. A system, comprising:
a processor;
a first array of non-volatile memory cells to cache one or more blocks of state information to be received from the processor; and
a second array of non-volatile memory cells to store a plurality of blocks of state information to be received from the processor;
wherein the one or more blocks of state information to be cached in the first array of memory cells comprises at least a subset of the plurality of blocks of state information to be stored in the second array of non-volatile memory cells; and
wherein the first and second arrays of non-volatile memory cells employ different memory technology.

19. The system of claim 18, wherein the non-volatile memory technology of the first array of non-volatile memory cells comprises a phase-change memory technology, and wherein the non-volatile memory technology of the second array of non-volatile memory cells comprises NAND technology.

20. The system of claim 18, wherein the first and the second array are incorporated into a memory device.
